(19) United States
(12) Patent Application Publication
(10) Pub. No.: US 2006/0201870 A1
(43) Pub. Date: Sep. 14, 2006

(54) Filter apparatus and droplet ejection device

(76) Inventors: Shinji Seto, Kanagawa (JP); Tomohiro Wada, Kanagawa (JP); Yoshihira Rai, Kanagawa (JP)

Correspondence Address: FILDES & OUTLAND, P.C., 20916 MACK AVENUE, SUITE 2, GROSSE POINTE WOODS, MI, 48236, US

(21) Appl. No.: 11/203,910

(22) Filed: Aug. 15, 2005

(30) Foreign Application Priority Data
Mar. 10, 2005 (JP) 2005-068220

(51) Int. Cl. B01D 35/28; B41J 2/015

(52) U.S. Cl. 210/435; 210/456; 347/20; 347/44

(57) ABSTRACT

A filter apparatus which features an inflow path, a first liquid chamber, a second liquid chamber, an outflow path and a filter. Liquid flows in at the inflow path. The first liquid chamber communicates with the inflow path. The second liquid chamber is disposed at an inner side of the first liquid chamber and communicates with the first liquid chamber. The outflow path communicates with the second liquid chamber and the liquid flows out at the outflow path. The filter is disposed between the first liquid chamber and the second liquid chamber.

### CROSS-REFERENCE TO RELATED APPLICATION

This application claims priority under 35 USC 119 from Japanese Patent Application No. 2005-068220, the disclosure of which is incorporated by reference herein.

### BACKGROUND OF THE INVENTION

1. Field of the Invention

The present invention relates to a filter apparatus and a droplet ejection device, and more particularly relates to a filter apparatus which removes waste matter, foreign bodies and the like from a liquid, and to a droplet ejection device which ejects liquid which has passed through the filter apparatus and been supplied to a droplet ejection head from nozzles of the droplet ejection head.

2. Description of the Related Art

At an inkjet recording device, which performs printing onto a recording medium by ejecting ink droplets from nozzles of a recording head, an ink filter (hereafter referred to as “filter”) is provided on an ink supply path to the recording head. The filter removes waste matter, foreign bodies and the like from the ink, in order to prevent clogging of the nozzles by the waste matter, foreign bodies and the like which are present in the ink, and to prevent a deterioration in ink ejection performance.

For example, among structures which supply ink from an ink cartridge to a recording head via a sub-tank, there are structures in which a filter is provided at an ink chamber (a pressure absorption chamber) in the sub tank (see, for example, Japanese Patent Application Laid-Open (JP-A) No. 9-277561), and there are structures in which two connected ink chambers are provided in a sub-tank, the ink chambers being disposed at an upstream side and a downstream side in an ink flow direction, and a filter is provided at an ink outflow aperture formed in the downstream side ink chamber (see, for example, JP-A No. 10-329330).

In recent years, with a view to raising printing speeds at inkjet recording heads, there has been a tendency to increase the number of nozzles that are provided at each recording head and/or to increase the frequency of cycles of ink discharge. Further, with a view to raising printed image quality, cross-sectional areas of nozzles are being made progressively smaller so as to make discharged droplets smaller.

As a result of these trends, forms of the above-mentioned filters are sought which are capable of removing finer waste matter and foreign bodies and which have little vulnerability to pressure damage. Consequently, filter pores have been getting smaller and filter areas have been getting larger. However, when the area of a filter is made larger, a recording head at which the filter is provided also increases in size. Accordingly, as a remedial measure therefor, division of a filter into plurality and arrangement of these filters in an array, so as to restrain an increase in the size of a head, has been considered.

However, in such a structure, a downstream side flow path of the filter is divided into plural branches. Consequently, if one of the branches of the flow paths is blocked by a bubble formed in the ink, flow rates in the other branches increase, ease of removal (elimination characteristics) of the bubble in the flow path that is blocked by the bubble is adversely affected, and this leads to a deterioration in ink ejection performance, which is a problem.

### SUMMARY OF THE INVENTION

In consideration of the circumstances described above, the present invention will provide a filter apparatus at which elimination characteristics of bubbles in a downstream side flow path of the filter are not adversely affected even when an area of the filter is increased. The present invention will also provide a droplet ejection device which is capable of restraining enlargement of a droplet ejection head when this filter apparatus is provided, while avoiding a reduction in droplet ejection capabilities.

A first aspect of the present invention provides a filter apparatus including: an inflow path, at which liquid flows in; a first liquid chamber, in fluid communication with the inflow path; a second liquid chamber, which is provided at an inner side of the first liquid chamber and is in fluid communication with the first liquid chamber; an outflow path at which liquid flows out, which is in fluid communication with the second liquid chamber; and a filter, which is provided between the first liquid chamber and the second liquid chamber.

In the structure described above, liquid flows in through the inflow path, flows into the first liquid chamber, and flows to the second liquid chamber which is provided inside the first liquid chamber. The liquid then flows out from the second liquid chamber along the outflow path. Herein, when the liquid flows from the first liquid chamber into the second liquid chamber, the liquid passes through the filter which is provided between the first liquid chamber and the second liquid chamber. Thus, waste matter, foreign bodies and the like which are present in the liquid are caught by the filter and removed from the liquid. In this manner, a filter function of the filter apparatus for removing foreign bodies and the like from the liquid is realized.

Accordingly, because the second liquid chamber is provided at the inner side of the first liquid chamber and the filter is provided between the first liquid chamber and the second liquid chamber in this manner, it is easy to make pores in the filter smaller, in order to enable the removal of smaller foreign bodies and the like, and to increase an area of the filter, in order to enable a reduction in pressure damage. Furthermore, with this structure, it is possible to increase the area of the filter simply, without adopting a structure in which, for example, the filter is divided into plural smaller filters to be arranged in an array and a downstream side flow path of the filter is divided into plural branches. Therefore, a deterioration in bubble elimination characteristics, as would occur in a case in which the downstream side flow path of the filter is divided into plural branches, will not result.

A second aspect of the present invention provides a droplet ejection device including: a droplet ejection head, which ejects droplets from a nozzle toward an object of ejection; a liquid storage portion, at which liquid to be supplied to the droplet ejection head is stored; and the filter apparatus according to the first aspect, which is provided between the droplet ejection head and the liquid storage portion.

When a droplet ejection device is equipped with the filter apparatus in the structure described above, it is possible to restrain enlargement of the droplet ejection head while avoiding a deterioration in droplet ejection performance.

### BRIEF DESCRIPTION OF THE DRAWINGS

Embodiments of the invention will be described in detail on the basis of the following figures, wherein:

FIG. 1 is a perspective view showing the exterior of a filter unit relating to a first embodiment of the present invention;

FIG. 2 is a perspective view showing the exterior of the filter unit of FIG. 1 and internal structure thereof in a partial breakaway;

FIG. 3 is an exploded perspective view showing a disassembled state of the filter unit of FIG. 1;

FIG. 4A is a sectional view, cut along line 4A-4A of FIG. 4B, showing a cross-section of the filter unit of FIG. 1;

FIG. 4B is a sectional view, cut along line 4B-4B of FIG. 4A, showing a cross-section of the filter unit of FIG. 1;

FIG. 5A is a sectional view, corresponding to FIG. 4A, which shows flows of ink in the filter unit of FIG. 1;

FIG. 5B is a sectional view, corresponding to FIG. 4B, which shows flows of ink in the filter unit of FIG. 1;

FIG. 6A is a perspective view showing the exterior of a filter unit relating to a second embodiment of the present invention;

FIG. 6B is an exploded perspective view showing a disassembled state of the filter unit of FIG. 6A;

FIG. 7A is a front view showing the exterior of the filter unit of FIG. 6A;

FIG. 7B is a right side view showing the exterior of the filter unit of FIG. 6A;

FIG. 8A is a sectional view, cut along line 8A-8A of FIG. 7B, showing a cross-section of the filter unit of FIG. 6A;

FIG. 8B is a sectional view cut along line 8B-8B of FIG. 8A;

FIG. 8C is a sectional view cut along line 8C-8C of FIG. 8B;

FIG. 8D is a sectional view cut along line 8D-8D of FIG. 8A;

FIG. 8E is a sectional view cut along line 8E-8E of FIG. 8A;

FIG. 9A is a sectional view, corresponding to FIG. 8A, which shows flows of ink in the filter unit of FIG. 6A;

FIG. 9B is a sectional view corresponding to FIG. 8B;

FIG. 9C is a sectional view corresponding to FIG. 8D;

FIG. 9D is a sectional view corresponding to FIG. 8E;

FIG. 10A is a front sectional view showing a state in which the filter unit of FIG. 6A is assembled to an inkjet recording head relating to a third embodiment of the present invention;

FIG. 10B is a right side sectional view showing the state in which the filter unit of FIG. 6A is assembled to the inkjet recording head relating to the third embodiment of the present invention;

FIG. 11 is an exploded perspective view showing a state in which a filter is withdrawn from the filter unit of FIG. 6A;

FIG. 12A is a front sectional view showing a filter unit relating to a fourth embodiment of the present invention; and

FIG. 12B is a front sectional view showing flows of ink in the filter unit relating to the fourth embodiment of the present invention.

### DETAILED DESCRIPTION OF THE INVENTION

Hereafter, filter apparatuses (filter units), which are to be used in inkjet recording devices, relating to embodiments of the present invention will be described with reference to the drawings.

### First Embodiment

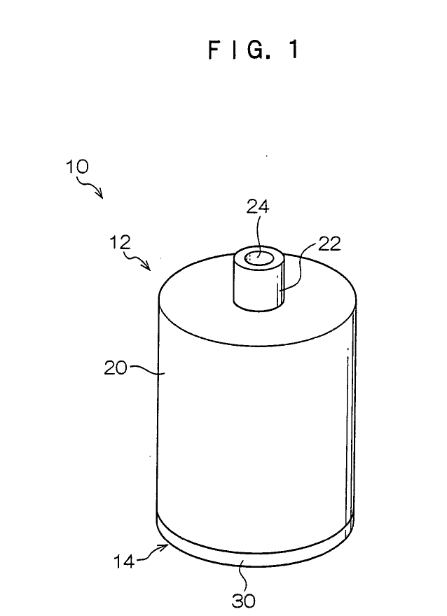

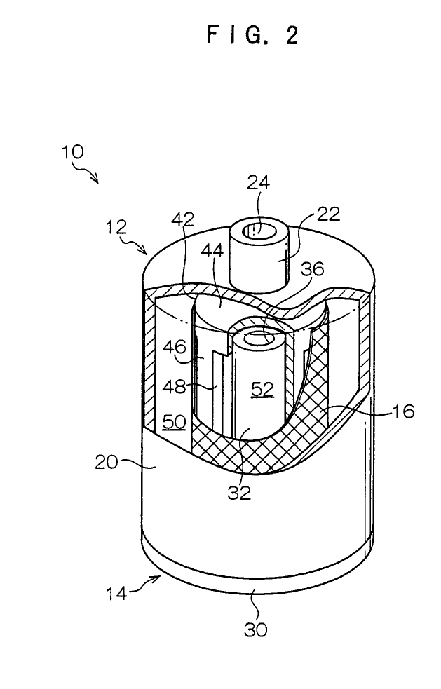

A filter unit 10 of the present embodiment is shown in FIGS. 1 and 2. As shown in the drawings, the filter unit 10 has a cylindrical form. The filter unit 10 is formed as a unit in which structural members of the filter unit 10, which will be described below, are integrally assembled. In the form of this unit, the filter unit 10 is connected at an ink supply path between an inkjet recording head and an ink cartridge, which are mounted at an inkjet recording device.

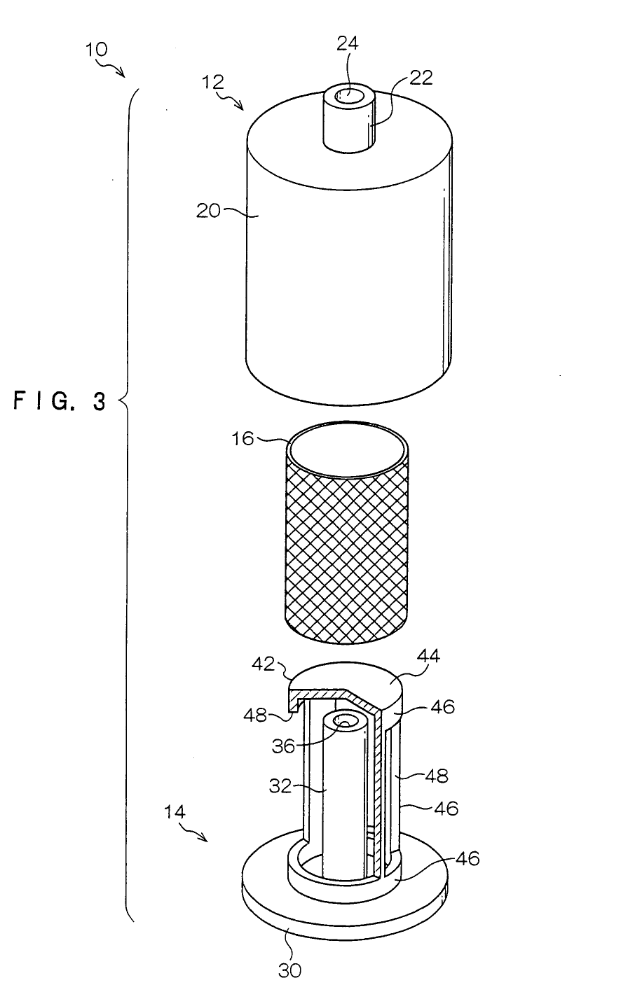

As shown in FIG. 3, the filter unit 10 is structured by a casing member 12, a cap member 14 and a filter 16.

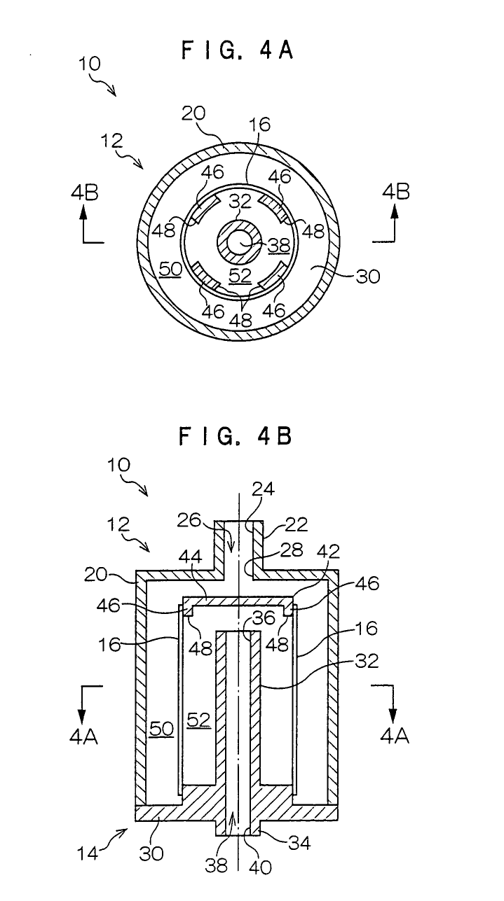

The casing member 12 is provided with a case main body 20 formed in a hollow circular tube shape, a lower face of which includes a circular opening. A circular tube-form upstream side connection portion 22 is provided protruding from an axial center portion of a circular upper face of the case main body 20. A circular through-hole is formed in the upstream side connection portion 22 to pass therethrough in a vertical direction of the drawings. An upper end portion of the circular through-hole serves as an inflow aperture 24. As shown in FIG. 4B, this inflow aperture 24 is communicated with an interior cavity of the case main body 20 via an ink inflow path 26, which is formed by the circular through-hole. A lower end portion of the ink inflow path 26 serves as an ink chamber inlet 28, which is an entry aperture of an ink chamber 50, which will be described later.

The cap member 14 is provided with a circular disc-form bottom cap main body 30, which has a diameter the same as an external diameter of the case main body 20. A circular tube-form channel portion 32 is provided protruding from an axial center portion of a circular upper face of the bottom cap main body 30. A circular tube-form downstream side connection portion 34 is provided protruding from an axial center portion of a circular lower face of the bottom cap main body 30. As shown in FIG. 4B, the downstream side connection portion 34 is formed with the same diameter as the channel portion 32 and is provided coaxially with the channel portion 32.

A circular through-hole is formed in the channel portion 32 and the downstream side connection portion 34, passing therethrough in the vertical direction of the drawings. An upper end portion of this circular through-hole serves as an ink chamber outlet 36, which is an exit aperture of an ink chamber 52, which will be described later. An ink outflow path 38 is formed by the circular through-hole. A lower end portion of the ink outflow path 38 serves as an outflow aperture 40 for ink. As shown in FIG. 4B, the outflow aperture 40 is communicated with the ink chamber 52 via the ink outflow path 38.

As shown in FIG. 3, a substantially circular tube-form partition wall portion 42 is also provided at the upper face of the bottom cap main body 30. The partition wall portion 42 is provided coaxially with the channel portion 32 and encloses the channel portion 32. A circular disc-form top wall portion 44 is provided at the partition wall portion 42. The top wall portion 44 is disposed to be separated from an upper end of the channel portion 32 (i.e., the ink chamber outlet 36) by a predetermined distance upward.

As shown in FIG. 4A, four openings 48 are formed in a circumferential wall portion (side wall portion) 46 of the partition wall portion 42. The openings 48 are formed at equidistant intervals (900 intervals) along the circumferential direction. The openings 48 are formed with rectangular shapes which are longer in the vertical direction. The openings 48 extend from a lower end portion vicinity of the circumferential wall portion 46 to an upper end portion vicinity of the same. Thus, the openings 48 have large opening areas.

As shown in FIG. 3, the filter 16 of the present embodiment is fabricated by machining a membrane-like mesh material, in which numerous microscopic pores are formed, into a circular tube shape. An inner diameter of this filter 16 is set to be slightly larger than an outer diameter of the partition wall portion 42. A length of the filter 16 in an axial direction (i.e., the vertical direction of the drawings) is set to be a little shorter than a height of the partition wall portion 42 but a little longer than a height of the openings 48.

Hence, as shown in FIGS. 2, 4A and 4B, the partition wall portion 42 of the cap member 14 is inserted into this filter 16, and the filter 16 is assembled so as to cover the circumferential wall portion 46. Here, when the filter 16 is being fitted around the partition wall portion 42, an upper end portion and a lower end portion of the filter 16 are adjusted so as to be disposed at an upper end portion vicinity and a lower end portion vicinity of the circumferential wall portion 46. In this state, the filter 16 is joined to the partition wall portion 42 by adhesion, thermal welding or the like. Hence, in this structure, the four openings 48 formed in the partition wall portion 42 are all covered with the filter 16.

Then, the partition wall portion 42 of the cap member 14, to which the filter 16 has been assembled, is inserted into the casing member 12 with the orientation shown in FIG. 3, the cap member 14 is positioned so as to be arranged coaxially with the casing member 12, and a peripheral edge portion of the upper face of the bottom cap main body 30 is joined to a peripheral edge portion of the lower face of the case main body 20 by adhesion or the like. In this manner, the filter unit 10 shown in FIGS. 1 and 2 is assembled. Inside the filter unit 10, as shown in FIG. 4B, the top wall portion 44 of the partition wall portion 42 is disposed at a position substantially intermediate to the ink chamber inlet 28 and the ink chamber outlet 36.

As shown in FIGS. 2, 4A and 4B, the ink chamber 50, which serves as a first liquid chamber, is formed inside this filter unit 10. The ink chamber 50 is demarcated by the case main body 20 of the casing member 12 and the bottom cap main body 30, partition wall portion 42 and filter 16 of the cap member 14. At an inner side of this ink chamber 50, that is, at the interior of the partition wall portion 42 and the filter 16, the ink chamber 52 is formed to serve as a second liquid chamber. Hence, the ink chamber 50 is communicated with the inflow aperture 24 via the ink inflow path 26, and the ink chamber 52 is communicated with the outflow aperture 40 via the ink outflow path 38. Further, the ink chamber 50 constitutes a structure surrounding an outer side face of the ink chamber 52 (i.e., an outer circumferential face of the circumferential wall portion 46). Furthermore, the filter 16 is disposed at the ink chamber 50 side, which is an upstream side in an ink flow direction, of the outer side face of the ink chamber 52.

Next, operation of the filter unit 10 of the present embodiment as described above will be described.

As mentioned above, the filter unit 10 is used by being connected between a recording head and an ink cartridge of an inkjet recording device. The filter unit 10 is set in the inkjet recording device with the upstream side connection portion 22 connecting to an ink cartridge side and the downstream side connection portion 34 connecting to a recording head side.

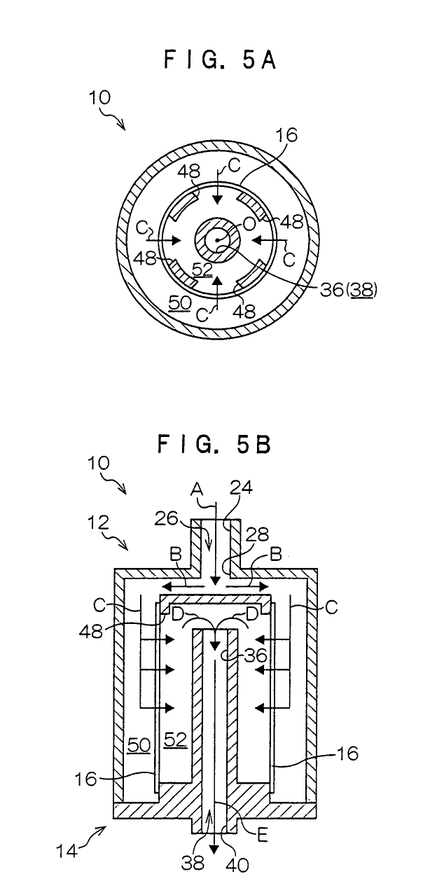

FIGS. 5A and 5B show flows of ink passing through the interior of the filter unit 10 with arrows. When an ink supply operation of the inkjet recording device is commenced, first, ink flows into the ink inflow path 26 through the inflow aperture 24 of the filter unit 10 (arrow A). This ink flows through the ink chamber inlet 28 to the ink chamber 50 (arrows B), and is charged into the ink chamber 50. Then, the ink passes out of the ink chamber 50 through the filter 16 and the openings 48 and flows into the ink chamber 52 (arrows C), and is charged into the ink chamber 52. Hence, the ink flows through the ink chamber outlet 36 to the ink outflow path 38 (arrows D), passes through the ink outflow path 38 and flows out from the outflow aperture 40 (arrow E).

When, in these flows of ink inside the filter unit 10, the ink flows from the ink chamber 50 into the ink chamber 52, the ink passes through the filter 16. Thus, waste matter, foreign bodies and the like which are present in the ink are trapped by the filter 16 and removed from the ink. In this manner, a filtering function of the filter unit 10, for removing foreign bodies and the like from ink, is realized.

Because, as described above, the ink chamber 52 is provided at the inner side of the ink chamber 50 and the filter 16 is provided between the ink chamber 50 and the ink chamber 52, it is possible to make pores of the filter 16 smaller, in order to enable the extraction of smaller foreign bodies and the like, and it is possible to increase an area of the filter 16, in order to enable a reduction in pressure damage. In particular, because the present embodiment has the structure in which the outer side face of the ink chamber 52 (i.e., the outer circumferential face of the circumferential wall portion 46) is circumferentially completely surrounded by the ink chamber 50, it is possible to make the area of the filter 16 arranged along the outer side face of the ink chamber 52 even larger. Consequently, the effect of reducing pressure damage can be enhanced.

Thus, with this structure, it is possible to increase the area of the filter simply, without adopting a structure in which, for example, the filter is divided into plural smaller filters to be arranged in an array and a downstream side flow path of the filter is divided into plural branches. Therefore, there is no deterioration in bubble elimination characteristics, as would occur in such a structure, and bubbles that occur at the downstream side of the filter 16 are excellently eliminated.

Moreover, in the filter unit 10 of the present embodiment, as shown in FIG. 5A, the directions of flow lines of ink flowing from the ink chamber 50 into the ink chamber 52 (the arrows C) all coincide with lines passing through a center point O of the ink chamber outlet 36 (and the ink outflow path 38), and the filter 16 is disposed on a circular circumference with respect to the center O. Therefore, in this structure, fluid resistances of flow paths toward the ink chamber outlet 36 are the same for flow paths of any cross section as shown in FIG. 5A. Consequently, flow rates of ink passing through the filter 16 and flowing into the ink chamber 52 towards the ink chamber outlet 36 are the same from any direction. As a result, there will be fewer sluggish portions during ink flows, and bubble elimination characteristics are made even more excellent.

Further yet, because, in the filter unit 10 of the present embodiment, the structural members are integrally assembled to form a unit, a replacement operation is simpler than with, for example, a filter apparatus with a divided structure or the like.

### Second Embodiment

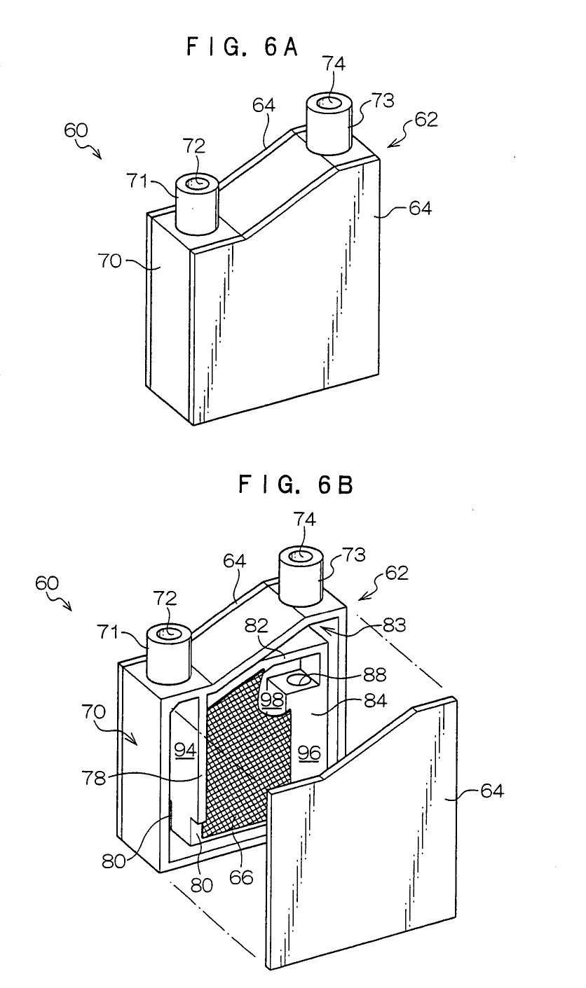

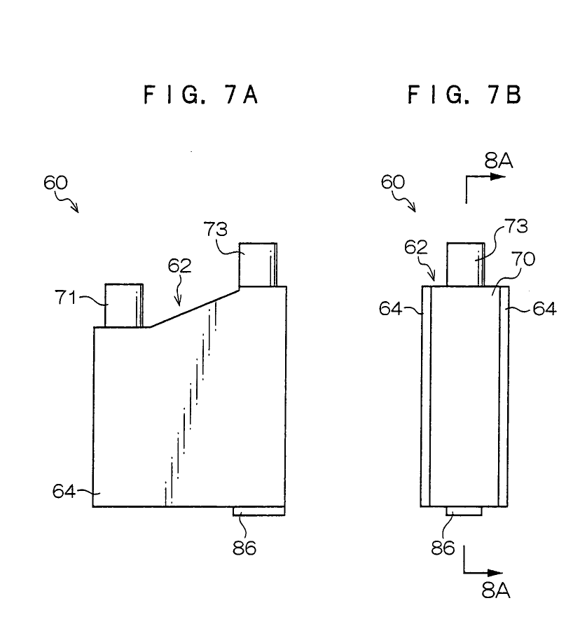

As shown in FIGS. 6A, 6B, 7A and 7B, a filter unit 60 relating to a second embodiment is formed in a flat-form substantially trapezoid solid shape. This filter unit 60 is used at an inkjet recording device with a structure which supplies ink from an ink tank through a circulation-type ink supply path (an ink circulation flow path) to a recording head. Similarly to the first embodiment, structural members of the filter unit 60 are integrally assembled to be formed into a unit.

As shown in FIGS. 6A to 8E, the filter unit 60 is structured with a casing member 62, two side plate members 64 and two filters 66.

The casing member 62 is provided with a case main body 70 in a substantially trapezoid tube form, of which a front face and a rear face are opened in the directions shown in FIGS. 6A and 6B, and whose interior is formed as a cavity. A left portion and a right portion of an upper face of the case main body 70 are respectively formed as substantially horizontal flat faces, with the right portion being a little higher than the left portion. Between the left portion and the right portion, a diagonal face which is inclined upward from the left side toward the right side is formed.

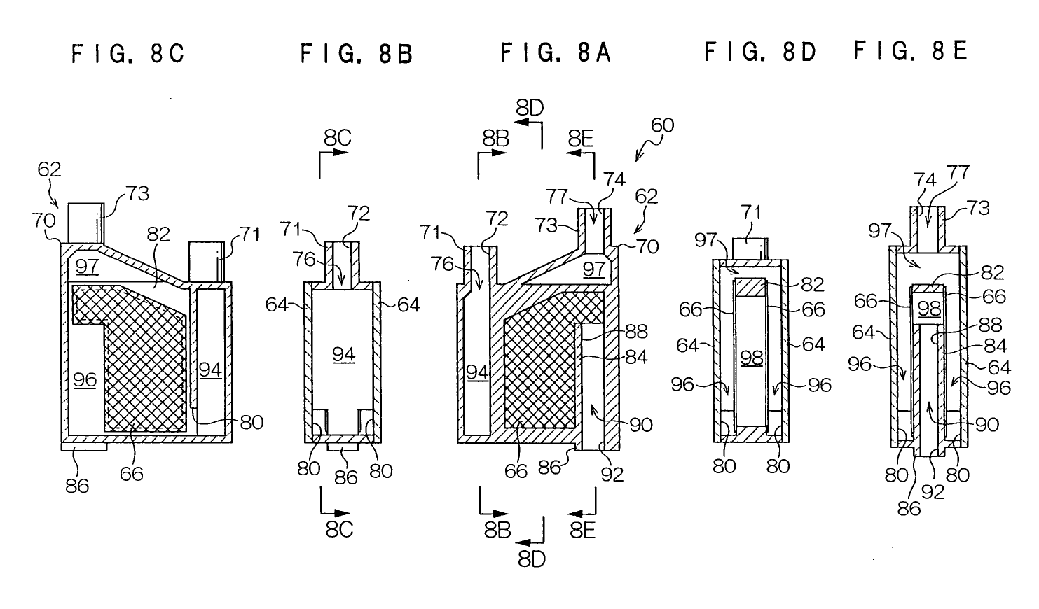

A circular tube-form upstream side connection portion 71 is provided protruding from the left portion of the upper face of the case main body 70. A circular through-hole is formed in the upstream side connection portion 71 to pass therethrough in a vertical direction of the drawings. An upper end portion of the circular through-hole serves as an inflow aperture 72 for the ink. As shown in FIGS. 8A and 8B, this inflow aperture 72 is communicated with the interior space of the case main body 70 via an ink inflow path 76, which is formed by the circular through-hole.

A circular tube-form circulation side connection portion 73 is provided protruding from the right portion of the upper face of the case main body 70. A circular through-hole is formed in the circulation side connection portion 73 to pass therethrough in the vertical direction of the drawings. An upper end portion of this circular through-hole serves as a circulation outlet 74 for the ink. As shown in FIGS. 8A and 8E, this circulation outlet 74 is communicated with the interior space of the case main body 70 via an ink circulation path 77, which is formed by the circular through-hole.

A partition wall portion 78 is provided at a left side of the interior of the case main body 70. The partition wall portion 78 is disposed at a position which is separated from a left interior wall face by a predetermined distance toward the right, and extends in the vertical direction parallel with the left interior wall face. Incisions with laterally-facing squared U-shape in cross-section are formed at a front side and a rear side of a lower end portion of the partition wall portion 78. Ink chamber inlets (communication apertures) 80 are structured by these incisions. The ink chamber inlets 80 are communication apertures between an ink chamber 94 and an ink chamber 96, which will be described later, and serve as an entry aperture of the ink chamber 96.

A frame wall portion 82, which is formed in a frame shape, is provided inside the casing member 62 at the right side of the partition wall portion 78. An aperture portion, which passes through in a front-rear direction, is formed above the frame wall portion 82. A bubble collection portion 97, which will be described later, is structured by this aperture portion.

As shown in FIGS. 8D and 8E, a front face and a rear face of the frame wall portion 82 are set apart from a front face and a rear face of the case main body 70 by predetermined distances (which are equal distances) to the inside.

A tubular channel portion 84 is provided inside this frame wall portion 82. The channel portion 84 extends in the vertical direction along a right interior wall face. A downstream side connection portion 86 is provided protruding from a right end portion of a lower face of the casing member 62 at a position corresponding with the channel portion 84, as shown in FIGS. 7A and 7B.

A circular through-hole is formed in the channel portion 84 and the downstream side connection portion 86, passing therethrough in the vertical direction of the drawings. An upper end portion of this circular through-hole serves as an ink chamber outlet 88, which is an exit aperture of an ink chamber 98, which will be described later. An ink outflow path 90 is formed by the circular through-hole. A lower end portion of the ink outflow path 90 serves as an outflow aperture 92 for the ink. As shown in FIGS. 8A and 8E, the outflow aperture 92 is communicated with the ink chamber 98 via the ink outflow path 90.

As is shown in FIG. 8C, the filters 66 which are used in the filter unit 60 of the present embodiment are fabricated by machining to cut a membrane-like mesh material to the shapes of a front face opening and a rear face opening of the frame wall portion 82. Outer profiles of these filters 66 are set to be a size larger than the shapes of the openings of the frame wall portion 82.

Hence, as shown in FIGS. 6A and 6B and FIGS. 8C to 8E, these filters 66 are assembled to a front face and a rear face of the frame wall portion 82 in a state in which the filters 66 cover the front face opening and the rear face opening of the frame wall portion 82. Thus, the two filters 66 are disposed to oppose one another and be substantially parallel. Similarly to the first embodiment, the filters 66 are adjusted such that outer peripheral end portions of the filters 66 are disposed at front face edge portions and rear face edge portions of the frame wall portion 82. In this state, the filters 66 are joined to the frame wall portion 82 by adhesion, thermal welding or the like.

Then, the side plate members 64 are joined, by adhesion or the like, to a front face and a rear face of the casing member 62 in which the filters 66 have been assembled, with the orientations shown in FIG. 6B. In this manner, the filter unit 60 shown in FIGS. 6A, 7A and 7B is assembled.

Thus, as shown in FIGS. 8A to 8C, the ink chamber 94 is formed inside this filter unit 60, at the left side. The ink chamber 94 is demarcated by the case main body 70 and partition wall portion 78 of the casing member 62, and the side plate members 64. Further, the ink chamber 96 (the first liquid chamber) is provided at a front side, a rear side and an upper side substantially at the middle of the interior of the filter unit 60 (with an inverted substantial ‘U’ shape in the cross-sections of FIGS. 8D and 8E). The ink chamber 96 is demarcated by the case main body 70, the partition wall portion 78, the frame wall portion 82, the filters 66 and the side plate members 64. An upper portion space of this ink chamber 96 serves as the bubble collection portion 97. Further still, at an inner side of the ink chamber 96, that is, inside the frame wall portion 82 and the filters 66, the ink chamber 98 (the second liquid chamber) is formed. Hence, the ink chamber 94 is communicated with the inflow aperture 72 via the ink inflow path 76, the ink chamber 96 is communicated with the ink chamber 94 via the two ink chamber inlets 80, the bubble collection portion 97 at the upper portion of the ink chamber 96 is communicated with the circulation outlet 74 via the ink circulation path 77, and the ink chamber 98 is communicated with the outflow aperture 92 via the ink outflow path 90. Further, the ink chamber 96 constitutes a structure sandwiching the ink chamber 98.

The filters 66 are disposed at boundary faces between the ink chamber 96 and the ink chamber 98 (i.e., at the front face and the rear face of the frame wall portion 82), and are disposed at the ink chamber 96 side, which is an upstream side in an ink flow direction, of these boundary faces. The ink chamber outlet 88 is disposed at a position higher than the two ink chamber inlets 80, and the ink chamber outlet 88 is disposed at a vicinity of a highest location of the ink chamber 98.

Next, operation of the filter unit 60 of the present embodiment as described above will be described.

As mentioned earlier, the filter unit 60 is used by being connected to an ink circulation flow path of an inkjet recording device. The filter unit 60 is set in the inkjet recording device with the upstream side connection portion 71 connecting to an upstream side end portion of the ink circulation flow path, which is connected to an ink tank, the circulation side connection portion 73 connecting to a downstream side end portion of the ink circulation flow path, and the downstream side connection portion 86 connecting to a recording head.

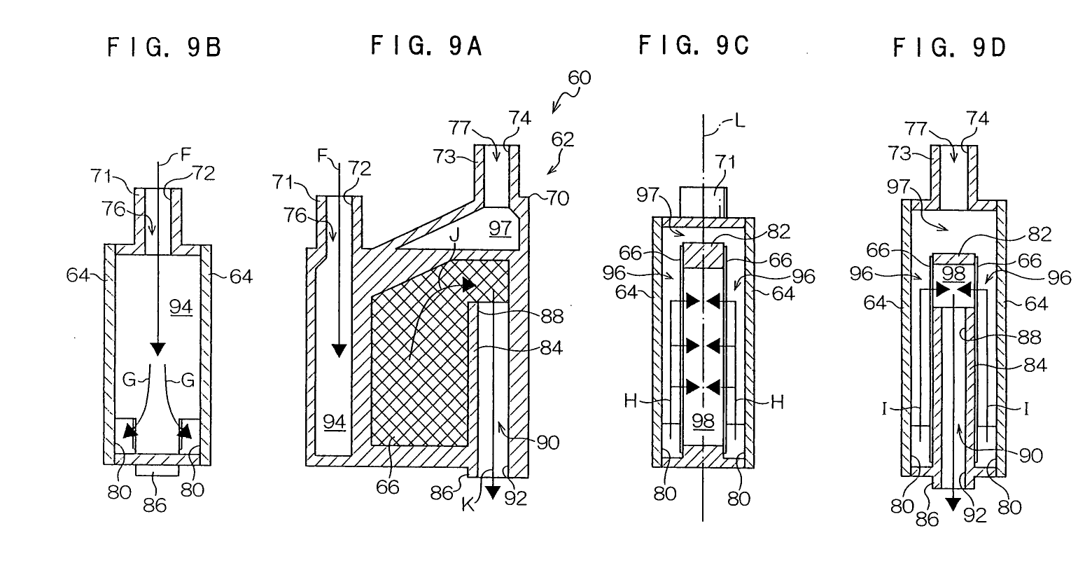

FIGS. 9A to 9D show flows of ink passing through the interior of the filter unit 60 with arrows. When ink is to be supplied through the ink circulation flow path of the inkjet recording device to the recording head, first, ink flows into the ink inflow path 76 through the inflow aperture 72 of the filter unit 60 (arrow F). This ink passes through the ink chamber 94 and flows through the two ink chamber inlets 80 into the ink chamber 96 (arrows G). Then, the ink passes through the two filters 66 from the ink chamber 96 and flows into the ink chamber 98 (arrows H). Hence, the ink flows through the ink chamber outlet 88 into the ink outflow path 90 (arrow J), passes through the ink outflow path 90 and flows out from the outflow aperture 92 (arrow K).

When, in these flows of ink inside the filter unit 60, the ink flows from the ink chamber 96 into the ink chamber 98, the ink passes through the two filters 66. Thus, waste matter, foreign bodies and the like which are present in the ink are trapped by the two filters 66 and removed from the ink. In addition, ink bubbles which are present in the ink chamber 96 do not move toward the ink chamber 98 but rise and move into the bubble collection portion 97, and are eliminated through the ink circulation path 77 during circulation of the ink.

Similarly to the first embodiment, because the ink chamber 98 is provided at the inner side of the ink chamber 96 and the filters 66 are provided between the ink chamber 96 and the ink chamber 98, it is possible to make pores of the filters 66 smaller, in order to enable the extraction of smaller foreign bodies and the like, and it is possible to increase an area of the filters 66, in order to enable a reduction in pressure damage. In particular, because the present embodiment has the structure in which the ink chamber 98 is sandwiched by the ink chamber 96, it is possible to make the overall filter area (the sum of the areas of the two filters 66) provided at the boundary faces between the ink chamber 96 and the ink chamber 98 (at the front face and rear face of the frame wall portion 82) larger. As a result, the effect of reducing pressure damage can be enhanced. Accordingly, with the filter unit 60 too, elimination characteristics of bubbles that occur at the downstream side of the filters 66 are excellent.

Further, the filter unit 60 of the present embodiment has the structure in which the two filters 66 with matching shapes are arranged to face one another in parallel, and ink that passes through the filters 66 is eliminated through the single ink chamber outlet 88. Therefore, it is possible to dispose a larger filter more compactly inside the filter unit, and it is possible to structure the filter unit 60 with a compact form (a narrow form). Moreover, because there is only one of the ink outflow path 90 (the ink chamber outlet 88) at the downstream side of the filters, bubble elimination characteristics can be improved in comparison with a structure in which plural ink outflow paths are provided downstream of a filter.

Further still, in the case of the filter unit 60 of the present embodiment, as shown in FIG. 9C, the directions of flow lines of ink flowing from the ink chamber 94 into the ink chamber 96 (the arrows H) are linearly symmetrical with respect to a center line L. Therefore, two flow paths from the ink chamber inlets 80 through the filters 66 toward the single ink chamber outlet 88 have identical forms. Because there is no imbalance between these two flow paths, bubble elimination characteristics are more excellent.

Further yet, in the present embodiment, because the ink chamber outlet 88 is disposed at a higher position than the ink chamber inlets 80, there is a rising flow in the flow of ink from the ink chamber inlets 80 to the ink chamber outlet 88 (the arrows H, I and J in FIGS. 9C, 9D and 9A). Because of this rising flow, bubbles moving upward in the ink will tend to be guided towards the ink chamber outlet 88, and the bubbles will pass through the ink chamber outlet 88 and be excellently eliminated. Furthermore, in the present embodiment, because the ink chamber outlet 88 is provided in the vicinity of the highest position inside the ink chamber 98, at which bubbles will tend to gather, characteristics of elimination of bubbles in the ink chamber 98 are even more excellent.

Moreover, in the case of the present embodiment too, because, similarly to the first embodiment, the structural members of the filter unit 60 are integrally assembled to form a unit, a replacement operation is simple.

### Third Embodiment

A third embodiment is a usage example of a case in which the filter unit 60 of the second embodiment is mounted at an inkjet recording head 100.

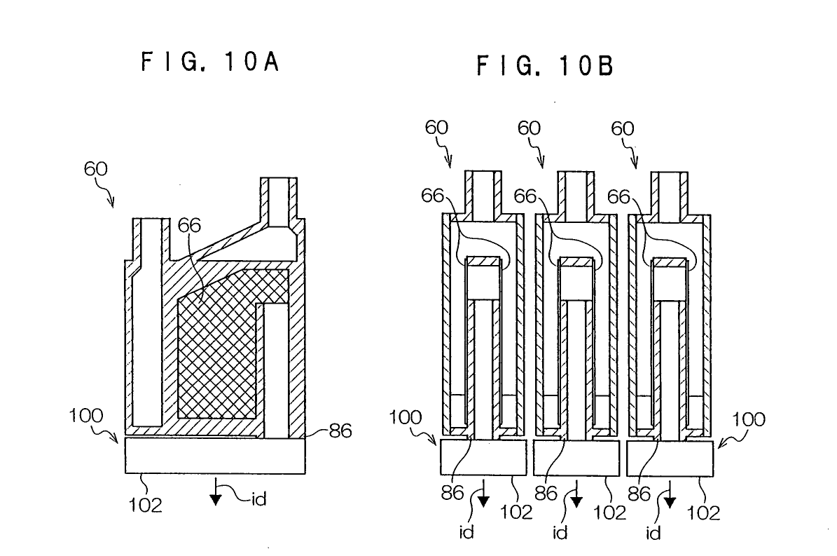

As shown in FIGS. 10A and 10B, the inkjet recording head 100 relating to the present embodiment, which serves as a droplet ejection device, is formed in a rectangular shape. A lower face of the inkjet recording head 100 in the drawings serves as a nozzle face 102, at which numerous nozzles for ejecting ink droplets (arrow id) are formed. The filter unit 60 is mounted at an upper face of the inkjet recording head 100.

Furthermore, as shown in the drawings, the nozzle face 102 and the upper face of the inkjet recording head 100 are formed with areas substantially the same as a lower face of the filter unit 60. When the downstream side connection portion 86 of the filter unit 60 is to be connected for assembly to the inkjet recording head 100, the upper face of the inkjet recording head 100 and the lower face of the filter unit 60 are brought together and arranged to be substantially parallel. Thus, the two filters 66 provided in the filter unit 60 are disposed with orientations substantially perpendicular to the nozzle face 102.

With the structure described above, in the present embodiment, even if the area of the filters 66 provided in the filter unit 60 is made larger, a footprint of the filter unit 60 on the nozzle face 102 of the inkjet recording head 100 will not become larger. Therefore, in a case in which the inkjet recording head 100 at which the filter unit 60 is mounted is plurally arranged, as shown in FIG. 10B, it is possible to arrange the nozzles at the plural heads with high density, and it is possible to structure the overall head with a compact form. Accordingly, with this inkjet recording device employing the filter unit 60, it is possible to raise a speed of printing and to keep the device small.

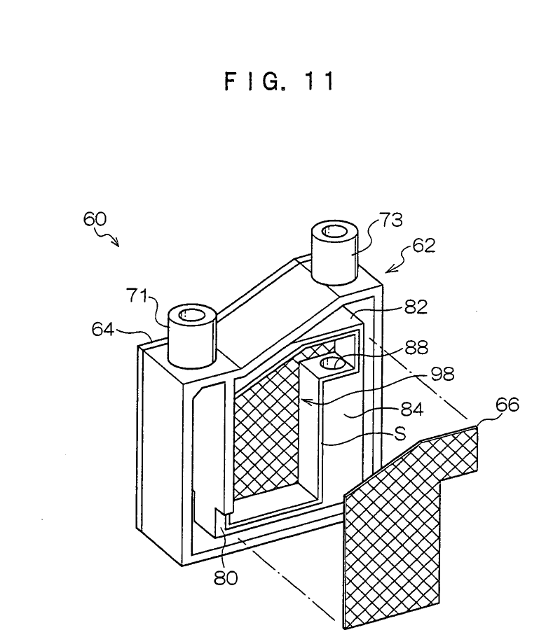

Now, as described above, this filter unit 60 is structured such that outer peripheral edge portions of the filters 66 are at the ink chamber 96 side of the boundary faces. Therefore, as shown in FIG. 11, a joining margin S, for joining of the filters 66 to the front face and rear face of the frame wall portion 82, is provided at front face peripheral edge portions and rear face peripheral edge portions of the frame wall portion 82, and there is no need to provide a joining margin for the filters inside the ink chamber 98. Therefore, a reduction in filter area consequent to attachment of the filters 66 can be avoided. Furthermore, even in a case in which, for example, volume of the ink chamber 98 is made smaller, it is possible to maintain a large filter area. Consequently, it is possible, by reducing volume of the ink chamber 98 in this manner, to keep down an amount of suction when ink suction is performed to remove bubbles in the filter unit 60 through the nozzles, and thus to reduce amounts of ink that are wastefully consumed in maintenance of the recording head.

Further, as described above, there is no joining margin for the filters at the downstream side of the filters. Therefore, there is no need for structure for widening flows of ink as far to the joining margin. As a result, because structure at the downstream side for broadening a flow of ink that has passed through the filter can be excluded, it is possible to improve bubble elimination characteristics downstream of the filters.

Further yet, burrs, tiny residual pieces (chips) and the like are likely to be formed at outer peripheral edge portions of the filters by a cutting process during fabrication. These burrs and residual pieces can be separated from the filters by pressure of the flow of ink, and float free in the ink. Even though this occurs, as described above, the outer peripheral edge portions of the filters 66 are disposed at the ink chamber 96 side, which is the upstream side. Accordingly, the residual pieces and the like that have separated from the outer peripheral edge portions of the filters 66 float free in the ink chamber 96 and, when the ink passes through the filters 66, are caught at the filters 66 and removed from the ink. In respect of the removal of such foreign bodies originating from filters, in the filter unit 10 of the first embodiment too, outer peripheral edge portions of the filter 16 are disposed at the ink chamber 50 side, which is the upstream side, and therefore a similar effect is realized.

### Fourth Embodiment

A fourth embodiment is a variant example in which a baffle plate (baffle portion) is provided in the filter unit 60 of the second embodiment.

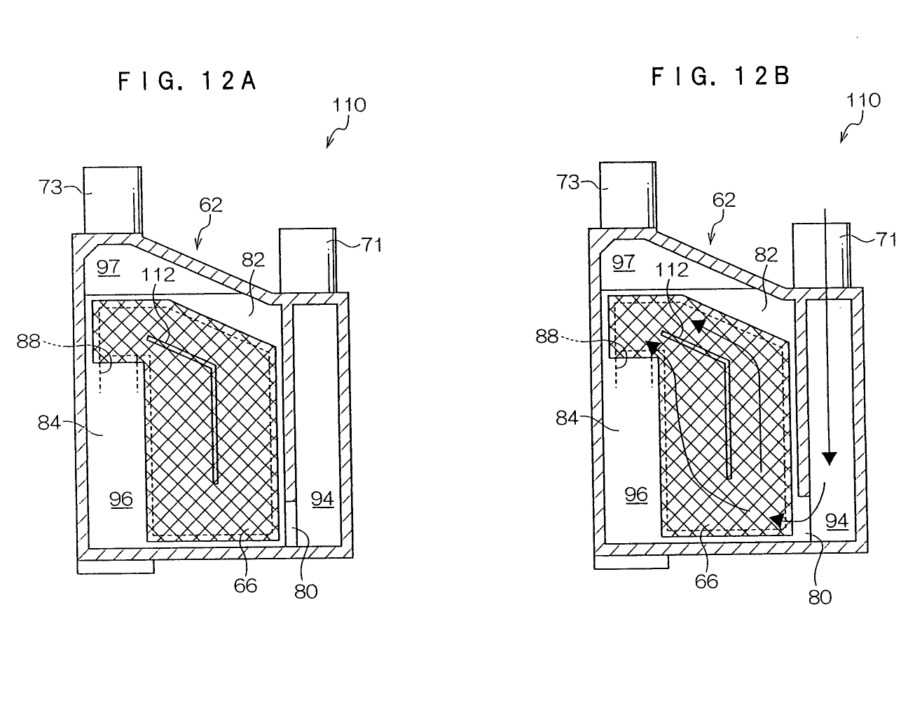

A filter unit 110 of the present embodiment is shown in FIGS. 12A and 12B. Flat plate-form baffle plates 112 are provided at interior faces of the side plate members 64 (see FIGS. 6A and 6B). Each baffle plate 112 is located inside the ink chamber 96 and is disposed at a substantially central portion of the filter 66, as shown in the drawings. A lower portion side of the baffle plate 112 extends in a vertical direction, and an upper portion side of the baffle plate 112 is inflected with respect to the lower portion side, to extend diagonally upward toward the left of the drawings (i.e., toward the ink chamber outlet 88).

With the structure described above, in the filter unit 110 of the present embodiment, ink flowing parallel to the filters 66 is flow-regulated by the baffle plates 112, and a distribution of flow speeds in the ink chamber 98 is made narrower. Consequently, bubble elimination characteristics in the ink chamber 98 are further improved.

The present invention has been described in detail by means of the first to fourth embodiments. However, the present invention is not limited to these embodiments, and various other modifications can be applied within the scope of the present invention.

For example, in the filter unit 10 of the first embodiment, in the structure in which the outer side face of the downstream side ink chamber is surrounded by the upstream side ink chamber, the filter 16 is formed in a single circular tube shape. However, number and shape of the filter in such a case may be altered, to be a divided structure, to have a polygonal form, or the like.

Further, in the filter unit 60 of the second embodiment, in the structure in which the downstream side ink chamber is sandwiched by the upstream side ink chamber, the two filters 66 are provided at the boundary faces between the two ink chambers (the front face and the rear face of the frame wall portion 82). However, in such a case, it is also possible, for example, to provide a filter at a top face of the frame wall portion 82, and it is possible to provide three or more filters at three or more boundary faces.

Further again, in the filter unit 110 of the fourth embodiment, the baffle plates 112 are provided in the upstream side ink chamber 96. However, such a baffle plate may be provided in the ink chamber 98. Furthermore, the baffle portion featuring the flow-regulation function is not limited to the flat plate form described above, and could be structured by a protrusion portion whose cross-sectional form is a triangular shape, a trapezoid shape or the like.

Further yet, the present invention is not limited to the inkjet recording device mentioned above, but can also be applied to other droplet ejection devices, such as pattern formation devices which eject droplets in order to form patterns of semiconductors and the like, and the like.

In a filter apparatus relating to an embodiment of the present invention, as described above, a first liquid chamber is provided so as to surround an outer side face of a second liquid chamber, and a filter is disposed along the outer side face.

Accordingly, with this structure in which the outer side face of the second liquid chamber is surrounded by the first liquid chamber, the area of the outer side face can be made larger, and consequently the area of the filter provided along the outer side face can be made larger.

Further, the outer side face may include a circular circumferential face, with the filter including a circular tube shape and an outflow path being disposed at a substantially axial central position of this tubular filter.

As a result of the outer side face of the second liquid chamber being formed as a circular circumferential face, the filter being formed in the tubular shape along the circular circumferential face and the outflow channel being provided at the substantially axial central position of the filter, flow rates of ink that passes through the filter and flows into the second liquid chamber towards the outflow channel are the same in all directions. Consequently, sluggish portions that arise during ink flows are reduced, and bubble elimination characteristics are more excellent. Furthermore, with this circular tube filter, the shape of this filter surrounding the outer side face is simpler than in a case in which, for example, the outer side face is a polygonal face and the filter has a polygonal tube shape, or the like. Thus, fabrication is easier.

Further, the first liquid chamber may be provided so as to sandwich the second liquid chamber, with the filter being disposed at a boundary face between the first liquid chamber and the second liquid chamber.

With a structure in which the second liquid chamber is sandwiched by the first liquid chamber, the area of a boundary face between the first liquid chamber and the second liquid chamber can be made larger, and consequently the area of the filter provided at the boundary face can be made larger.

Further, the boundary face may include plural boundary faces, with plural the filter being disposed at the plurality of boundary faces.

When the plurality of boundary faces is provided in the structure in which the second liquid chamber is sandwiched by the first liquid chamber, the plurality of filters can be arranged to, for example, oppose one another (being parallel) at this plurality of boundary faces, or to be arranged in a polygonal shape or the like. Thus, it is possible to arrange a filter with a large area compactly inside the filter apparatus and it is possible to reduce the scale of the device.

Further, two of the filters may have substantially matching shapes and be disposed to oppose one another, with an outflow path being disposed at a substantially central position between the two filters.

When the two filters with substantially the same shape are arranged to face one another and the outflow channel is provided at the substantially central position between the two filters, a balance is maintained between two flow channels passing through the two filters from the first liquid chamber and flowing into the second liquid chamber toward the outflow channel. Thus, bubble elimination characteristics are more excellent.

Further, a liquid chamber inlet for allowing liquid from an inflow path to flow into the first liquid chamber, and a liquid chamber outlet for allowing liquid in the second liquid chamber to flow out toward an outflow path may be provided, with the liquid chamber outlet being disposed at a higher position than the liquid chamber inlet.

Because the liquid chamber outlet is disposed at a higher position than the liquid chamber inlet, there is a rising flow in a flow of liquid from the liquid chamber inlet to the liquid chamber outlet. Because of this rising flow, bubbles, which move upward in the liquid, tend to be guided toward the liquid chamber outlet, and the bubbles are excellently eliminated through the liquid chamber outlet.

Further still, the liquid chamber outlet may be disposed at a vicinity of a highest position of the second liquid chamber.

Bubbles which are present in the second liquid chamber tend to accumulate in the vicinity of the highest position of the second liquid chamber. Consequently, because the liquid chamber outlet is provided at the vicinity of the highest position of the second liquid chamber, bubble elimination characteristics in the second liquid chamber are even more excellent.

Further, an outer peripheral edge portion of a filter may be disposed at a first liquid chamber side.

Because the outer peripheral edge portion of the filter is disposed at the first liquid chamber side, it is not necessary to provide an attachment margin (joining margin) for attachment of the filter in the second liquid chamber. As a result, it is possible to avoid a reduction in filter area consequent to attachment of the filter.

Further, a baffle portion, which controls a flow of liquid so as to flow parallel with the filter, may be provided at at least one of the first liquid chamber and the second liquid chamber.

As a result, liquid flowing in parallel with the first liquid chamber/second liquid chamber is flow-regulated by the baffle portion, and a distribution of flow speeds in the liquid chamber is narrowed. Consequently, bubble elimination characteristics in the liquid chamber are further improved.

Furthermore, the inflow path, the first liquid chamber, the second liquid chamber, the outflow path and the filter may be integrally assembled to form a unit.

When the structural members of the filter apparatus are integrally assembled to form a unit, the filter apparatus can be replaced as a unit item. Thus, a replacement operation is simple.

Further, at a droplet ejection device relating to an embodiment of the present invention, a filter may be disposed with an orientation which is substantially perpendicular to a nozzle face at which a nozzle of the droplet ejection head is formed.

Because the filter is disposed in the orientation which is substantially perpendicular to the nozzle face, even if area of the filter is increased, a footprint thereof at the nozzle face need not become larger. Thus, in a case in which a droplet ejection head to which the filter apparatus is attached is arranged in plurality, the nozzles can be provided with high density at the plural heads, and an overall head can be constituted with a small form.

Because a filter apparatus relating to the embodiments of the present invention is structured as described above, even if a filter is increased in area, elimination characteristics of bubbles in a flow path at the downstream side of the filter will not be adversely affected. Moreover, because a droplet ejection device relating to the embodiments of the present invention, which is equipped with this filter apparatus, is structured as described above, it is possible to restrain an increase in size of a droplet ejection head and to avoid a deterioration in droplet ejection capabilities.

What is claimed is:

1. A filter apparatus comprising:
an inflow path, at which liquid flows in;
a first liquid chamber, in fluid communication with the inflow path;
a second liquid chamber, which is provided at an inner side of the first liquid chamber and is in fluid communication with the first liquid chamber;
an outflow path at which liquid flows out, which is in fluid communication with the second liquid chamber; and
a filter, which is provided between the first liquid chamber and the second liquid chamber.

2. The filter apparatus of claim 1, wherein the first liquid chamber is provided so as to surround an outer side face of the second liquid chamber, and the filter is disposed along the outer side face.

3. The filter apparatus of claim 2, wherein the outer side face includes a circular circumferential face, the filter includes a circular tube shape, and the outflow path is disposed at a substantially axial central position of this tubular filter.

4. The filter apparatus of claim 1, wherein the first liquid chamber is provided so as to sandwich the second liquid chamber, and the filter is disposed at a boundary face between the first liquid chamber and the second liquid chamber.

5. The filter apparatus of claim 4, wherein the boundary face includes a plurality of boundary faces, and a plurality of the filter are disposed at the plurality of boundary faces.

6. The filter apparatus of claim 5, wherein two of the filters have substantially matching shapes and are disposed to oppose one another, and the outflow path is disposed at a substantially central position between the two filters.

7. The filter apparatus of claim 1, further comprising a liquid chamber inlet for allowing liquid from the inflow path to flow into the first liquid chamber, and a liquid chamber outlet for allowing liquid in the second liquid chamber to flow out toward the outflow path, wherein the liquid chamber outlet is disposed at a higher position than the liquid chamber inlet.

8. The filter apparatus of claim 7, wherein the liquid chamber outlet is disposed at a vicinity of a highest position of the second liquid chamber.

9. The filter apparatus of claim 1, wherein an outer peripheral edge portion of the filter is disposed at a first liquid chamber side.

10. The filter apparatus of claim 1, wherein a baffle portion, which controls a flow of liquid that flows parallel with the filter, is provided at at least one of the first liquid chamber and the second liquid chamber.

11. The filter apparatus of claim 1, wherein the inflow path, the first liquid chamber, the second liquid chamber, the outflow path and the filter are integrally assembled to form a unit.

12. A droplet ejection device comprising:
a droplet ejection head, which ejects droplets from a nozzle toward an object of ejection;
a liquid storage portion, at which liquid to be supplied to the droplet ejection head is stored; and
the filter apparatus of claim 1, which is provided between the droplet ejection head and the liquid storage portion.

13. The droplet ejection device of claim 12, wherein the filter is disposed with an orientation which is substantially perpendicular to a nozzle face at which the nozzle of the droplet ejection head is formed.
